(19) United States
(12) Patent Application Publication
(10) Pub. No.: US 2014/0054402 A1
(43) Pub. Date: Feb. 27, 2014

(54) Rotary crushing pair with uneven surfaces

(71) Applicant: Xingliang Zhu, Yiwu (CN)

(72) Inventor: Xingliang Zhu, Yiwu (CN)

(21) Appl. No.: 14/115,296

(22) PCT Filed: Apr. 30, 2012
(86) PCT No.: PCT/CN2012/074955

§ 371 Date: Nov. 1, 2013

(30) Foreign Application Priority Data
May 1, 2011 (CN) 201120145167.9
May 1, 2011 (CN) 201120145206.5

(51) Int. Cl. B02C 4/30; B02C 2/00

(52) U.S. Cl. CPC B02C 4/30; B02C 2/005
USPC 241/236; 241/198.1; 241/254

(57) ABSTRACT

A rotary crushing pair with uneven surfaces for cone crushers and roller crushers includes: a first crushing part and a second crushing part interacting with each other, wherein two crushing surfaces forming the crushing pair are uneven surfaces; the uneven surfaces are formed by single-helical ribs, loop ribs, mesh-like ribs, etc. By replacing a conventional solid smooth plate-like design with an uneven surface design of the rotary crushing pair, a main crushing mechanism, pressing, of conventional cone crushers and roller crushers is replaced by a combination of effective crushing mechanisms such as splitting, folding, twisting and cutting for fully eliminating slipping and greatly increasing crushing efficiency of the crusher.

### CROSS REFERENCE OF RELATED APPLICATION

This is a U.S. National Stage under 35 U.S.C 371 of the International Application PCT/CN2012/074955, filed Apr. 30, 2012, which claims priority under 35 U.S.C. 119(a-d) to CN 201120145206.5, filed May 1, 2011 and CN 201120145167.9, filed May 1, 2011.

### BACKGROUND OF THE PRESENT INVENTION

1. Field of Invention

The present invention relates to a technical field of crusher, and more particularly to a rotary crushing pair with uneven surfaces.

2. Description of Related Arts

There are many crushers. The most widely used crushers are cone crushers and roller crushers that are suitable for crushing raw material in industries of metallurgy, construction, road building, chemistry and silicate, specifically for ores and rocks with medium and above medium hardness. The cone crusher and the roller crusher are suitable for moderately and finely crushing all kinds of ores and rocks because of high efficiency, low energy consumption and uniform product sizes.

There are many crushing mechanisms. The cone crusher and the roller crusher crush by pressing mechanism. The structure of the cone crusher is so different from that of the roll crusher, but the crushing mechanisms are similar. The cone crusher and the roller crusher both utilize a rotary crushing pair. However, difference is that: the crushing pair of the cone crusher is formed by an internal surface and an external face of two cones; the crushing pair of the roller crusher is formed by two external surfaces of two cylinders.

The cone crusher and the roller crusher have advantages as follows: both crushing pairs provide whole course work (which is different from jaw crushers, wherein the jaw crusher has a back stroke with no work provided when a main shaft is working, so that the jaw crusher can only provide half course work), which means advanced principle and high crushing efficiency.

Disadvantages of the crushing pairs of the conventional cone crushers and roll crushers are that:

A) most crushing pairs have a solid smooth plate-like structure with a large material contact area, which causes small crushing pressure and is not conducive to crushing;

B) materials are likely to slip when being crushed by the solid smooth plate-like crushing pair, which lowers the crushing efficiency; and

C) single crushing method is used, wherein only pressing is a main crushing method and the crusher lacks combination of effective crushing methods such as splitting, folding, squeezing, twisting and cutting.

### SUMMARY OF THE PRESENT INVENTION

An object of the present invention is to provide a rotary crushing pair with uneven surfaces with a simple structure, a low cost and high crushing efficiency for increasing crushing efficiency of conventional crushers.

Accordingly, in order to accomplish the above object, the present invention provides a rotary crushing pair with uneven surfaces, comprising:

a first crushing part; and

a second crushing part;

wherein the first crushing part is opposite to the second crushing part for forming a crushing pair, two surfaces forming the crushing pair are uneven surfaces.

Two preferred embodiments are provided according to the present invention for cone crushers and roller crushers with a pressing mechanism.

A) For the cone crusher, the first crushing part is a static cone, the second crushing part is a dynamic cone; an internal loop crushing surface of the static cone covers an external loop crushing surface of the dynamic cone for forming the crushing pair; a rotation eccentric angle is provided between a static cone center axis and a dynamic cone center axis; the internal loop crushing surface and the external loop crushing surface are uneven surfaces.

B) For the roller crusher, the first crushing part and the second crushing part are rollers with parallel axes and rotating in opposite directions; external surfaces of the rollers contact with each other for forming the crushing pair; the external surfaces are uneven surfaces.

Performance of the crushing pair according to the present invention is better than performance of a solid smooth plate-like crushing pair, wherein:

first, the surfaces of the crushing pair are the uneven surfaces, which provides a small contact area; with a same total crushing force of the crusher, the small contact area provides a large pressure (wherein Pressure=Total crushing force/Contact area); the above advantage is greatly conducive to improvement of the performance of the crusher;

second, surfaces of the conventional solid smooth plate-like crushing pair (formed by the static cone and the dynamic cone, or the rollers) are smooth; therefore, materials are likely to slip when squeezed, and the materials are not crushed while slipping; that is to say, slipping will counteract crushing efficiency of a crushing stroke of the crushing pair; crushing surfaces according to the present invention are the uneven surfaces in such a manner that a probability of slipping is greatly lowered and the crushing efficiency of the crushing pair is increased, which is another advantage of the crushing pair with the uneven surfaces; and

third, according to the present invention, the main crushing mechanism, pressing, of the solid smooth plate-like crushing pair is replaced by a combination of effective crushing mechanisms such as splitting, folding, twisting and cutting for providing an advanced crushing pair with functions of:

A) splitting: wherein when the materials are on a blade-like metal surface with cusped edges and are squeezed, a tensile stress is generated inside the materials; when the tensile stress reaches a limit, the material is crushed by splitting; the solid smooth plate-like crushing pair mainly provides a pressing function while working; however, the crushing pair with the uneven surfaces has a blade-like convex part for providing the splitting function for materials with large sizes;

B) folding: wherein when the materials are on a surface with first convex metal parts with certain distances therebetween and are squeezed by second convex metal parts on an opposite surface which are engaged with the first metal edges, the materials are bent and deformed; when a bending stress reaches a bending strength limit, the material is crushed by folding; the crushing pair provides the folding function for the materials with similar sizes similar to a size of the convex part while working; and

C) squeezing: wherein when the size of the material is almost the same as a distance between teeth of a tooth plate or an aperture, the material will be broken by being squeezed; a small part will be peeled off from the material squeezed, which means being crushed by squeezing; most materials with the small sizes will be crushed by squeezing in a crushing chamber in the crushing pair with the uneven surfaces.

Core technologies of the present invention are as follows. The rotary crushing pair with the uneven surfaces is designed for replacing the conventional solid smooth plate-like crushing pair. The main crushing mechanism, squeezing and pressing, of the solid smooth plate-like crushing pair is replaced by the combination of the effective crushing mechanisms such as splitting, folding, twisting and cutting for fully eliminating slipping and greatly increasing the crushing efficiency of the crusher.

Preferably, the uneven surface is formed by single-helical ribs, the rib on the first crushing part has an opposite spiral direction with respect to the rib on the second crushing part; the ribs form a convex surface, other parts of the first or second crushing part form a concave surface.

A) For the cone crusher, arrangement of the opposite ribs on the external crushing surface of the first crushing part and the internal crushing surface of the second crushing part fully utilizes a characteristic of directional force feeding of helical structures (for example, if a rotation direction of the dynamic cone is clockwise when being look down, the spiral direction is left-handed; and the static cone is in contrast), which pushes the materials to a discharge outlet while crushing for improving the crushing efficiency.

B) For the roller crusher, arrangement of the opposite ribs on the rollers provides a cutting function (axially crushing by cutting) of the roller crusher. Because a cutting stress limit of the most materials is much lower than a pressing stress, cutting is more effective than pressing for crushing. The crushing mechanism is improved according to the present invention.

The uneven surfaces can be different.

Preferably, the uneven surface is formed by crossed double-helical ribs; the ribs form a convex surface, other parts of the first or second crushing part form a concave surface. The crossed double-helical ribs provided on the crushing surfaces (of the static cone and the dynamic cone, or the rollers) form grid-like rhombic meshes.

A net-like structure is formed by the crushing surfaces. Therefore, harshness of the crushing surfaces is increased in such a manner that a friction force is increased, slipping is prevented and the crushing efficiency is improved.

Preferably, the uneven surface is formed by loop ribs; the ribs form a convex surface, other parts of the first or second crushing part form a concave surface.

A) For the cone crusher, arrangement of the loop ribs on the external crushing surface of the first crushing part and the internal crushing surface of the crushing part provides an axial cutting function to the crusher with the pressing mechanism. The crushing mechanism is as follows. The dynamic cone of the cone crusher is designed to rotate with an eccentric angle. Therefore, if the dynamic cone is changed from a loose state to a tight state, a contact point of the materials will move from bottom to top (vertically). If the crushing surfaces are the solid smooth plate-like surface, the movement will not provide the cutting function (wherein most power generated is lost by slipping, and a small part of the power provides an up and down twisting force). When the loop ribs are provided on the crushing surfaces, the loop ribs on the dynamic cone and the static cone will provide an up and down cutting force (which is an axial cutting crushing force) on the materials. Furthermore, the ribs will obliquely cut into the materials according to the axial rotation of the dynamic cone, which is conducive to crushing.

Preferably, a horizontal plane where the loop ribs of the static cone locate is vertical to the static cone center axis; a horizontal plane where the loop ribs of the dynamic cone locate is vertical to the dynamic cone center axis; distances between the neighboring loop ribs on the external loop crushing surface are gradually smaller from a top to a bottom of the dynamic cone; distances between the neighboring loop ribs on the internal loop crushing surface are smaller and smaller from a top to a bottom of the static cone.

The distances between the neighboring loop ribs on the external loop crushing surface are gradually smaller from the top to the bottom of the dynamic cone; the distances between the neighboring loop ribs on the internal loop crushing surface are gradually smaller from the top to the bottom of the static cone. And the upper materials are bigger than the lower materials. Therefore, an upper part of the loop rib is designed to be wider than a lower part of the loop rib for further crushing, in such a manner that the materials are crushed more finely.

B) For the roller crusher, arrangement of the loop ribs on the rollers provides a fold-line-like chamber. With a same length, the fold-line-like chamber has a longer effective chamber than a straight-line-like chamber, which increases a crushing yield.

Preferably, the uneven surface is formed by meshes; mesh edges form a convex surface, other parts of the first or second crushing part form a concave surface; the mesh is rhombic, rectangular or hexagonal. The meshes provided on the crushing surfaces (of the static cone and the dynamic cone, or the rollers) provide full twisting and cutting functions of the crushing pair in such a manner that a large bite force of the crusher is provided. The large bite force is very conducive to the crusher. And the large bite force is represented as that: a) an inlet of the crushing chamber has a strong biting (which means material intake) ability; and b) in a crushing procedure, the materials are being crushed while being driven downwards, which means that the materials move towards the discharge outlet while being crushed for improving the crushing efficiency. The large bite force provided by the meshes has a significant effect according to the present invention.

Preferably, the mesh is a through hole. If a diameter of the through hole is defined and a discharge tunnel is provided on a back of the crushing surface, the material with a size smaller than the diameter (which means a qualified size) will be discharged in advance for preventing the materials from being over crushed and saving power. The through hole is utilized according to a preferred embodiment of the present invention.

Preferably, the mesh is a blind hole. Advantages of the blind hole are that the materials hit each other for decreasing wastage and saving costs. The materials hit each other because the materials in the meshes will hit (squeeze) the materials in the crushing chamber for crushing.

While crushing, materials will be stored in the meshes and the materials in the meshes will hit the materials in the crushing chamber for crushing. The crushing mechanism that the materials hit each other is realized by repeating the above step. Because an area of the meshes is more than 50% of an area of the crushing surface (only when the materials are very hard and strength of the tooth plate should be ensured, the ratio is lower than 50%), a probability that the materials hit each other is very high according to the present invention.

Besides the above significant effects, the present invention has advantages as follows.

A) The characteristic of directional force feeding of the helical structures (for example, if the rotation direction of the dynamic cone is clockwise when being look down, the spiral direction is left-handed; and the static cone is in contrast) is scientifically utilized according to the present invention, which pushes the materials to the discharge outlet while crushing.

B) In production of the crushing surface, quenching should be applied. That is to say, the fully heated crushing surface is immersed into water for being rapidly cooled and being strengthened. The crowded meshes on the crushing surface highly increase a contact area with the water, which is conducive to hardenability of quenching for improving hardness, wear resistance and life length of the crushing surface.

These and other objectives, features, and advantages of the present invention will become apparent from the following detailed description, the accompanying drawings, and the appended claims.

### BRIEF DESCRIPTION OF THE DRAWINGS

FIG. 1 is a sectional view of a static cone and a dynamic cone according to a preferred embodiment 1 of the present invention.

FIG. 2 is a perspective view of the dynamic cone in the FIG. 1 according to the preferred embodiment 1 of the present invention.

FIG. 3 is a sectional view of a static cone and a dynamic cone according to a preferred embodiment 2 of the present invention.

FIG. 4 is a front view of rollers according to a preferred embodiment 3 of the present invention.

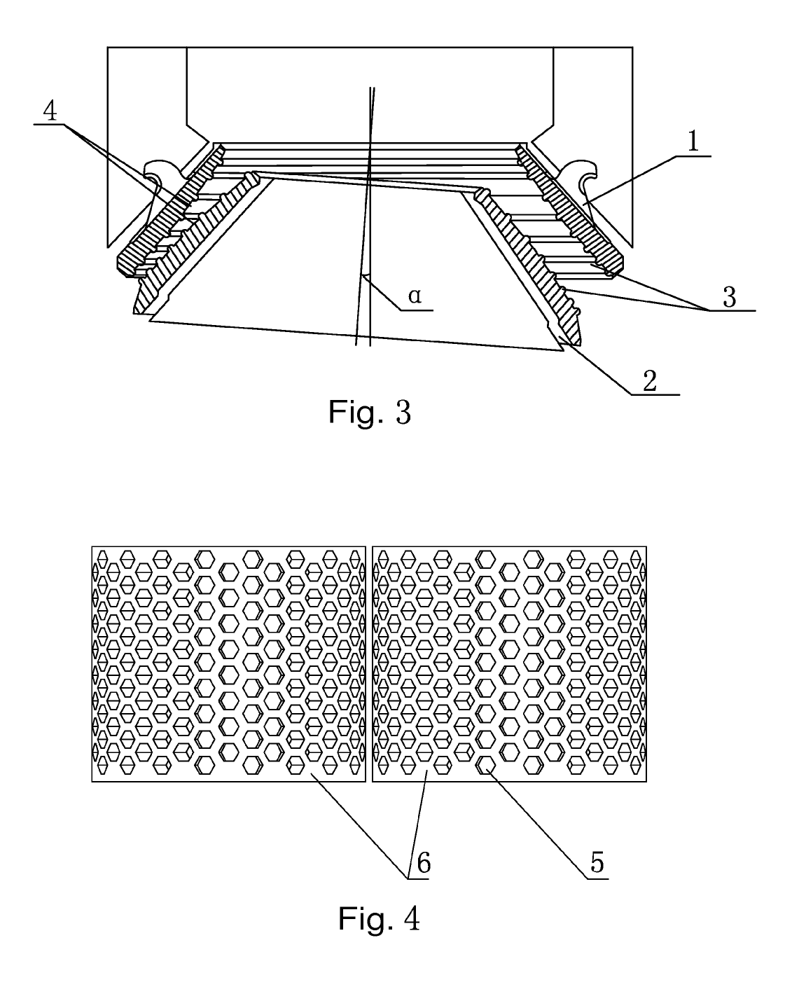

FIG. 3 is a perspective view of rollers according to a preferred embodiment 4 of the present invention.

Reference numbers of elements: 1-static cone, 2-dynamic cone, 3-convex surface, 4-concave surface, 5-mesh, 6-roller.

### DETAILED DESCRIPTION OF THE PREFERRED EMBODIMENT

Referring to the drawings, the present invention is further illustrated according to preferred embodiments.

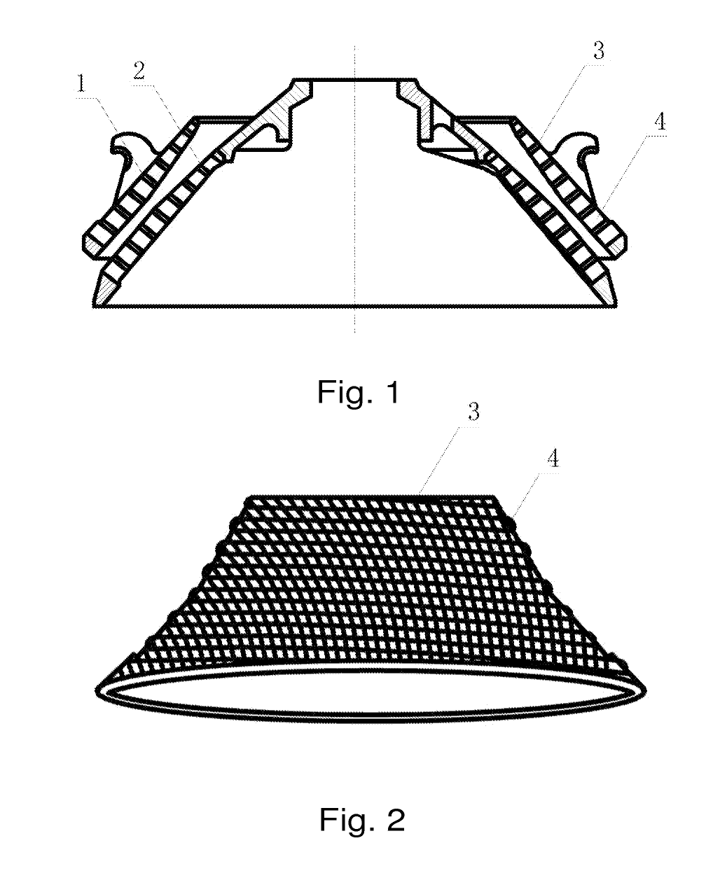

Preferred embodiment 1: referring to FIG. 1 of the drawings, a crushing pair for cone crushers is provided, comprising: a static cone 1 covering a dynamic cone 2 for forming the crushing pair, wherein an internal loop crushing surface of the static cone 1 covers an external loop crushing surface of the dynamic cone 2 for forming the crushing pair; a single-helical rib is evenly provided on the crushing surface; the rib forms a convex surface 3, other parts of the crushing surface form a concave surface 4; the rib on the external crushing surface of the dynamic cone 2 has an opposite spiral direction according to the rib on the internal crushing surface of the static cone 1.

Application: materials are fed into a crushing chamber; with rotation of the crushing surfaces, a strong friction force and a strong shearing force are provided on the materials between the dynamic cone 2 and the static cone 1; therefore, a combination of effective crushing mechanisms such as splitting, folding and squeezing is realized; and main crushing mechanisms, squeezing and pressing, are replaced by twisting and cutting crushing mechanisms; because a cutting stress limit of the most materials is lower than a pressing stress, crushing efficiency is improved.

Preferred embodiment 2: referring to the FIG. 1 and FIG. 2 of the drawings, crossed double-helical ribs are provided on an internal loop crushing surface of a static cone 1 and an external loop crushing surface of a dynamic cone 2; the double-helical ribs form a convex surface 3; grid-like rhombic meshes formed by the crossed double-helical ribs form a concave surface 4; the mesh is a through hole; others are the same as in the preferred embodiment 1.

Preferred embodiment 3: referring to the FIG. 2 of the drawings, the mesh is a blind hole; others are the same as in the preferred embodiment 2.

Preferred embodiment 4: referring to FIG. 3 of the drawings, loop ribs are provided on an internal loop crushing surface of a static cone 1 and an external loop crushing surface of a dynamic cone 2; a rotation eccentric angle a is provided between a static cone center axis and a dynamic cone center axis; a horizontal plane where the loop ribs of the static cone 1 locate is vertical to the static cone center axis; a horizontal plane where the loop ribs of the dynamic cone 2 locate is vertical to the dynamic cone center axis; distances between the neighboring loop ribs on the static cone 1 and the dynamic cone 2 are gradually smaller from a top to a bottom; the loop ribs form a convex surface 3; rib slots form a concave surface 4; after the loop ribs are provided on the crushing surfaces, the loop ribs on the dynamic cone 2 and the static cone 1 will provide an up and down cutting force on materials; furthermore, the ribs will obliquely cut into the materials according to axial rotation of the dynamic cone 1, which is conducive to crushing.

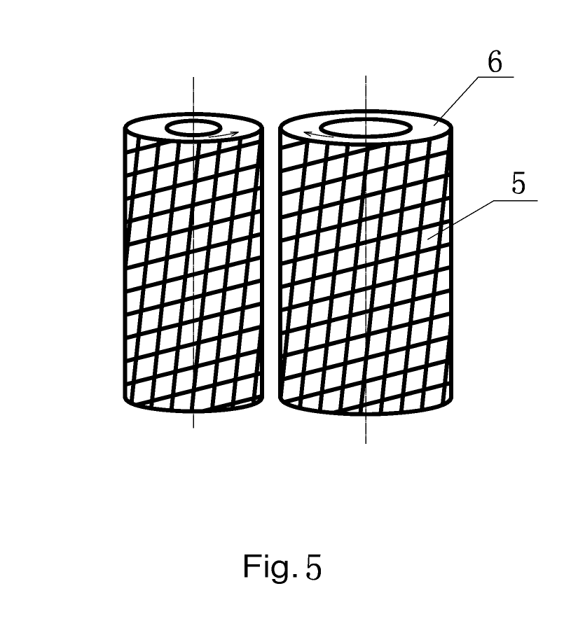

Preferred embodiment 5: referring to FIG. 4 of the drawings, a crushing pair for cone crushers is provided, comprising: two rollers 6 with parallel axes as well as same diameters and rotating in opposite directions; wherein a net-like structure is provided on surfaces of the rollers 6; the net-like structure is a cellular structure formed by hexagonal meshes 5, the mesh 5 is a through hole passing through the roller 6.

Preferred embodiment 6: referring to FIG. 5 of the drawings, a crushing pair for cone crushers is provided, comprising: two rollers 6 with parallel axes as well as different diameters and rotating in opposite directions; wherein a net-like structure is provided on surfaces of the rollers 6; the net-like structure is formed by grid-like rhombic meshes 5 formed by crossed double-helical ribs, the mesh 5 is rhombic and is a blind hole passing through the roller 6.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1-10. (canceled)

11. A rotary crushing pair with uneven surfaces, comprising:
a first crushing part; and
a second crushing part;
wherein said first crushing part is opposite to said second crushing part for forming a crushing pair, two surfaces forming said crushing pair are uneven surfaces.

12. The rotary crushing pair, as recited in claim 11, wherein said first crushing part is a static cone, said second crushing part is a dynamic cone; an internal loop crushing surface of said static cone covers an external loop crushing surface of said dynamic cone for forming said crushing pair; a rotation eccentric angle is provided between a static cone center axis and a dynamic cone center axis; said internal loop crushing surface and said external loop crushing surface are uneven surfaces.

13. The rotary crushing pair, as recited in claim 11, wherein said first crushing part and said second crushing part are rollers with parallel axes and rotating in opposite directions; external surfaces of said rollers contact with each other for forming said crushing pair; said external surfaces are uneven surfaces.

14. The rotary crushing pair, as recited in claim 11, wherein said uneven surface is formed by single-helical ribs, said rib on said first crushing part has an opposite spiral direction according to said rib on said second crushing part; said ribs form a convex surface, other parts of said first or second crushing part form a concave surface.

15. The rotary crushing pair, as recited in claim 12, wherein said uneven surface is formed by single-helical ribs, said rib on said first crushing part has an opposite spiral direction according to said rib on said second crushing part; said ribs form a convex surface, other parts of said first or second crushing part form a concave surface.

16. The rotary crushing pair, as recited in claim 13, wherein said uneven surface is formed by single-helical ribs, said rib on said first crushing part has an opposite spiral direction according to said rib on said second crushing part; said ribs form a convex surface, other parts of said first or second crushing part form a concave surface.

17. The rotary crushing pair, as recited in claim 11, wherein said uneven surface is formed by crossed double-helical ribs; said ribs form a convex surface, other parts of said first or second crushing part form a concave surface.

18. The rotary crushing pair, as recited in claim 12, wherein said uneven surface is formed by crossed double-helical ribs; said ribs form a convex surface, other parts of said first or second crushing part form a concave surface.

19. The rotary crushing pair, as recited in claim 13, wherein said uneven surface is formed by crossed double-helical ribs; said ribs form a convex surface, other parts of said first or second crushing part form a concave surface.

20. The rotary crushing pair, as recited in claim 11, wherein said uneven surface is formed by loop ribs; said ribs form a convex surface, other parts of said first or second crushing part form a concave surface.

21. The rotary crushing pair, as recited in claim 12, wherein said uneven surface is formed by loop ribs; said ribs form a convex surface, other parts of said first or second crushing part form a concave surface.

22. The rotary crushing pair, as recited in claim 13, wherein said uneven surface is formed by loop ribs; said ribs form a convex surface, other parts of said first or second crushing part form a concave surface.

23. The rotary crushing pair, as recited in claim 20, wherein a horizontal plane where said loop ribs of said static cone locate is vertical to said static cone center axis; a horizontal plane where said loop ribs of said dynamic cone locate is vertical to said dynamic cone center axis; distances between said neighboring loop ribs on said external loop crushing surface are gradually smaller from a top to a bottom of said dynamic cone; distances between said neighboring loop ribs on said internal loop crushing surface are gradually smaller from a top to a bottom of said static cone.

24. The rotary crushing pair, as recited in claim 21, wherein a horizontal plane where said loop ribs of said static cone locate is vertical to said static cone center axis; a horizontal plane where said loop ribs of said dynamic cone locate is vertical to said dynamic cone center axis; distances between said neighboring loop ribs on said external loop crushing surface are gradually smaller from a top to a bottom of said dynamic cone; distances between said neighboring loop ribs on said internal loop crushing surface are gradually smaller from a top to a bottom of said static cone.

25. The rotary crushing pair, as recited in claim 22, wherein a horizontal plane where said loop ribs of said static cone locate is vertical to said static cone center axis; a horizontal plane where said loop ribs of said dynamic cone locate is vertical to said dynamic cone center axis; distances between said neighboring loop ribs on said external loop crushing surface are gradually smaller from a top to a bottom of said dynamic cone; distances between said neighboring loop ribs on said internal loop crushing surface are gradually smaller from a top to a bottom of said static cone.

26. The rotary crushing pair, as recited in claim 11, wherein said uneven surface is formed by meshes; mesh edges form a convex surface, other parts of said first or second crushing part form a concave surface; said mesh is rhombic, rectangular or hexagonal.

27. The rotary crushing pair, as recited in claim 12, wherein said uneven surface is formed by meshes; mesh edges form a convex surface, other parts of said first or second crushing part form a concave surface; said mesh is rhombic, rectangular or hexagonal.

28. The rotary crushing pair, as recited in claim 13, wherein said uneven surface is formed by meshes; mesh edges form a convex surface, other parts of said first or second crushing part form a concave surface; said mesh is rhombic, rectangular or hexagonal.

29. The rotary crushing pair, as recited in claim 23, wherein said mesh is a through hole.

30. The rotary crushing pair, as recited in claim 23, wherein said mesh is a blind hole.
